(19) United States
(12) Patent Application Publication
(10) Pub. No.: US 2020/0126559 A1
(43) Pub. Date: Apr. 23, 2020

(54) CREATING MULTI-MEDIA FROM TRANSCRIPT-ALIGNED MEDIA RECORDINGS

(71) Applicant: Reduct, Inc., San Francisco, CA (US)

(72) Inventors: Robert Ochshorn, San Francisco, CA (US); Prabhas Pokharel, San Francisco, CA (US)

(73) Assignee: Reduct, Inc., San Francisco, CA (US)

(21) Appl. No.: 16/165,232

(22) Filed: Oct. 19, 2018

(51) Int. Cl. G10L 15/26; G10L 15/22

(52) U.S. Cl. CPC G10L 15/265; G10L 15/22

(57) ABSTRACT

Methods, systems, apparatus, and tangible non-transitory carrier media encoded with one or more computer programs for achieving highly accurate timing alignment between spoken words in an audio recording and the written words in the associated transcript, and creating multi-media from transcript-aligned media recordings.

### BACKGROUND

A transcript is a written rendering of dictated or recorded speech. Transcripts are used in many applications, including audio and video editing, closed-captioning, and subtitling. For these types of applications, transcripts include time codes that synchronize the written words with spoken words in the recordings.

Although the transcription quality of automated transcription systems is improving, they still cannot match the accuracy or capture fine distinctions in meaning as well as professional transcribers. In addition to transcribing speech into written words, professional transcribers oftentimes also enter time codes into the transcripts in order to synchronize the transcribed words with recorded speech. Although superior to automated transcription, manual transcription and time code entry is labor-intensive, time-consuming, and subject to error. Errors also can arise as a result of the format used to send transcripts to transcribers. For example, an audio recording may be divided into short segments and sent to a plurality of transcribers in parallel. Although this process can significantly reduce transcription times, it also can introduce transcription errors. In particular, when an audio segment is started indiscriminately in the middle of a word or phrase, or when there otherwise is insufficient audio context for the transcriber to infer the first one or more words, a transcriber will not be able to produce an accurate transcription.

A time-coded written transcript that is synchronized with an audio or video recording enables an editor or filmmaker to rapidly search the contents of the source audio or video based on the corresponding written transcript. Although text-based searching can allow a user to rapidly navigate to a particular spoken word or phrase in a transcript, such searching can be quite burdensome when many hours of source media content from different sources must be examined. In addition, to be most effective, there should be a one-to-one correlation between the search terms and the source media content; in most cases, however, the correlation is one-to-many resulting in numerous matches that need to be individually scrutinized.

Thus, there is a need in the art to reduce or eliminate transcription and time-coding errors in transcripts, and there is a need for a more efficient approach for finding the most salient parts of source media content transcripts.

### SUMMARY

This specification describes systems implemented by one or more computers executing one or more computer programs that can achieve highly accurate timing alignment between spoken words in an audio recording and the written words in the associated transcript, which is essential for a variety of transcription applications, including audio and video editing applications, audio and video search applications, and captioning and subtitling applications, to name a few.

Embodiments of the subject matter described herein can be used to overcome the above-mentioned limitations in the prior classification approaches and thereby achieve the following advantages. For example, the disclosed systems and methods can substantially reduce the burden of identifying the best media content, discovering themes, and making connections between seemingly disparate source media. Embodiments of the subject matter described herein include methods, systems, apparatus, and tangible non-transitory carrier media encoded with one or more computer programs for providing the search and categorization tools needed to rapidly parse source media recordings using highlights, make connections (thematic or otherwise) between highlights, and combine highlights into a coherent and focused multimedia file.

Other features, aspects, objects, and advantages of the subject matter described in this specification will become apparent from the description, the drawings, and the claims.

### DESCRIPTION OF DRAWINGS

FIG. 1 is a diagrammatic view of an exemplary live proceeding being recorded by multiple cameras and a standalone microphone.

FIG. 2A is a schematic diagram of a multi-media file created from transcript-aligned media recordings captured by two cameras and a microphone.

FIG. 2B is a flow diagram of a method of creating multi-media from transcript-aligned media recordings.

FIG. 3 is a schematic diagram of a network-based system for creating a master transcript associated with respective timing data.

FIG. 4 is a flow diagram of a network-based process for creating a master transcript associated with respective timing data.

FIG. 5 is a diagrammatic view of an example of a master transcript associated with respective timing data.

FIG. 6 is a schematic diagram of a network-based system for creating media that is force-aligned to a master transcript.

FIG. 7 is a diagrammatic view of a series of transcript segments with overlapping content.

FIG. 8 shows a table that shows three sequences of the same sequence of words with respective appearance locations along a timeline.

FIG. 9 shows a diagrammatic graph of word number as a function of time offset for an example master audio track and an example secondary audio track.

FIG. 10 is a flow diagram of a method of detecting drift in a track relative to a master track and correcting detected drift in the track.

FIG. 11 is a flow diagram of a method of incorporating secondary audio tracks into a master audio track based on a prioritized list of audio recordings.

FIG. 12 is a flow diagram of a method for replacing a section of a media track with a section of a force-aligned replacement media track.

FIG. 13 is a schematic view of a system that includes media editing application for creating multi-media from transcript-aligned media recordings.

FIG. 14 is a diagrammatic view of a source media page of the media editing application.

FIG. 15 is a diagrammatic view of the source media page of the media editing application showing an expanded search interface of the media editing application.

FIG. 16 is a diagrammatic view of a source media page of the media editing application showing the same expanded search interface shown in the source media landing page view provided in FIG. 15.

FIG. 17 is a diagrammatic view of a source media page of the media editing application showing a selection of the text in the transcript in a transcript section of the source media page and a highlights interface.

FIG. 18 is a diagrammatic view of a highlight page of the media editing application.

FIG. 19 is a diagrammatic view of a highlights page of the media editing application.

FIG. 20 is diagrammatic view of a composition landing page of the media editing application.

FIG. 21 is diagrammatic view of a composition selection page of the media editing application.

FIG. 22 is diagrammatic view of a composition editing page of the media editing application.

FIG. 23 is diagrammatic view of a composition editing page of the media editing application.

FIG. 24 is diagrammatic view of a composition editing page of the media editing application.

FIG. 25 is diagrammatic view of a composition editing page of the media editing application.

FIG. 26 is a block diagram of computer apparatus.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### Terms

A “computer” is any machine, device, or apparatus that processes data according to computer-readable instructions that are stored on a computer-readable medium either temporarily or permanently.

A “computer operating system” is a software component of a computer system that manages and coordinates the performance of tasks and the sharing of computing and hardware resources.

A “software application” (also referred to as software, an application, computer software, a computer application, a program, and a computer program) is a set of instructions that a computer can interpret and execute to perform one or more specific tasks.

A “data file” is a block of information that durably stores data for use by a software application.

The term “media” refers to a single form of information content, for example, audio or visual content. “Multimedia” refers to multiple forms of information content, such as, audio and visual content. Media and multimedia typically are stored in an encoded filed format (e.g., MP4).

A media “track” refers to one of multiple forms of information content in multimedia (e.g., an audio track or a video track). A media “sub-track” refers to a portion of a media track.

An “audio part” is a discrete interval that is segmented or copied from an audio track.

A “language element” is a discernably distinct unit of speech. Examples of language elements are words and phonemes.

“Time coding” refers to associating time codes with the words in a transcript of recorded speech (e.g., audio or video). Time coding may include associating time codes, offset times, or time scales relative to a master set of time codes.

“Forced alignment” is the process of determining, for each word in a transcript of an audio track containing speech, the time interval (e.g., start and end time codes) in the audio track that corresponds to the spoken word and its constituent phonemes.

A “tag” is an object that represents a portion of a media source. Each tag includes a unique category descriptor, one or more highlights, and one or more comments.

A “highlight” is an object that includes text copied from a transcript of a media source and the start and end time codes of the highlight text in the transcript.

A “comment” is an object that includes a text string that is associated with a portion of a transcript and typically conveys a thought, opinion, or reaction to the associated portion of the transcript.

Alignment

For a variety of transcription applications, it is essential to have accurate timing alignment between the spoken words in an audio recording and the written words in the associated transcript. For example: (1) in audio and video editing applications, accurate timing alignment between the spoken words in an audio recording and the written words in the associated transcript is required for the edits to the transcript text to be accurately applied to the corresponding locations in audio and video files; (2) in audio and video search applications, accurate timing alignment between the spoken words in an audio recording and the written words in the associated transcript is required for word searches on the transcript to accurately locate corresponding spoken words in the audio and video files; and (3) in captioning and subtitling applications, accurate timing alignment between the spoken words in an audio recording and the written words in the associated transcript is required for accurate timing alignment to avoid a disconcerting lag between the times when the words spoken in the audio and video files and the appearance of the corresponding words in the transcript. As explained in detail below, transcription accuracy can be improved by ensuring that transcribers are given sufficient preliminary audio context to comprehend the speech to be transcribed, and timing alignment can be improved by synchronizing multiple media source sub-tracks to a master transcript and by correcting timing errors (e.g., drift) that may result from using low quality or faulty recording equipment.

Exemplary Use Case

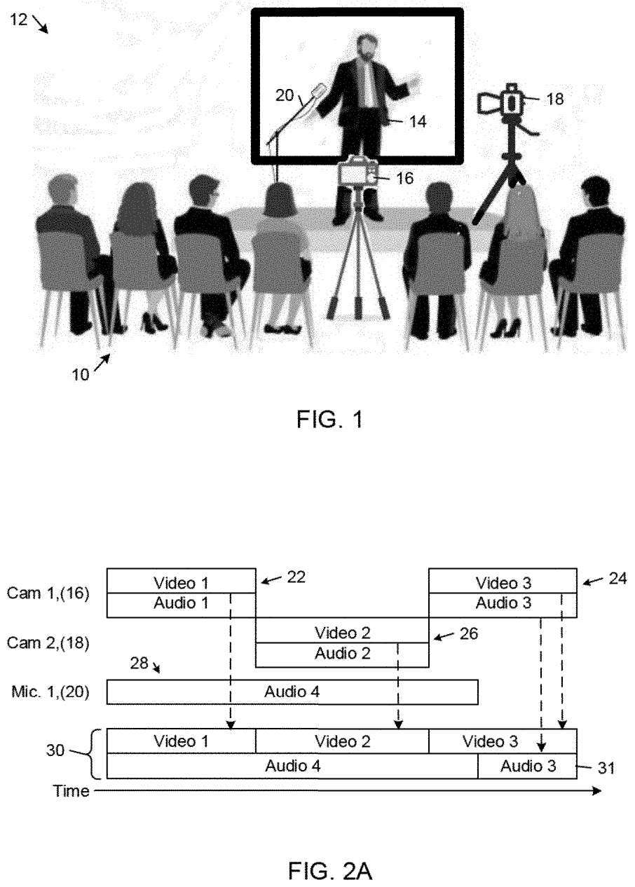

FIG. 1 shows an exemplary context for the embodiments described herein. In this example, a group of people 10 are gathered together in a space 12 for an event in which a speaker 14 is giving a presentation, talk, lecture, meeting, or the like that is being recorded by two video cameras 16, 18 and a standalone microphone 20. During the event, videographers (not shown) typically operate the video cameras 16, 18 and capture different shots of the speaker and possibly the audience. The video cameras 16, 18 and the microphone 20 may record the event continuously or discontinuously with gaps between respective recordings.

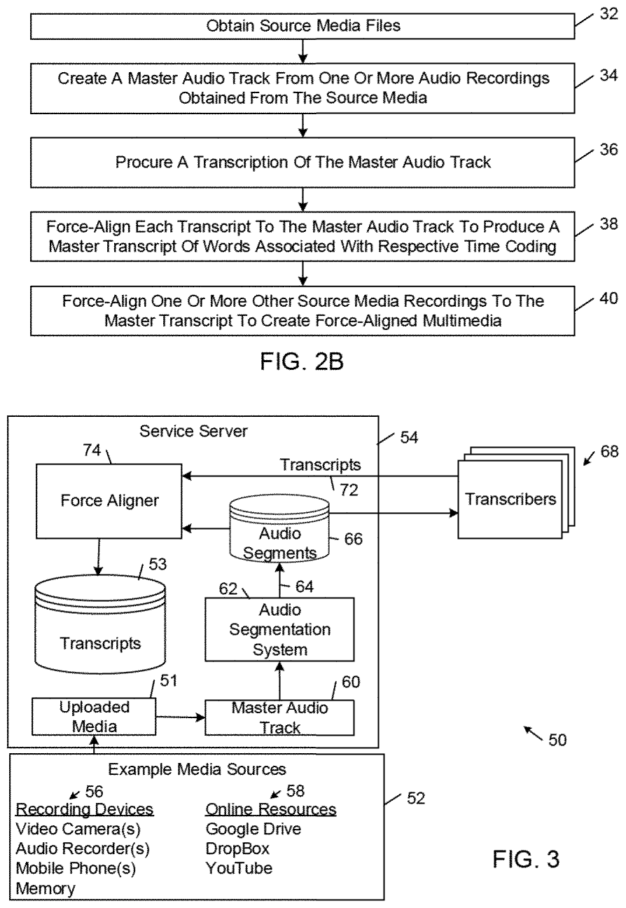

FIG. 2A shows an example timeline of the audio and video source media footage captured by the video cameras 16, 18 and the standalone microphone 20. In this example, the video camera 16 (Camera 1) captured two video recordings 22 and 24, where video clip 22 consists of an audio track (Audio 1) and a video track (Video 1) and video clip 24 consists of an audio track (Audio 3) and a video track (Video 3). Video camera 18 (Camera 2) captured a single video recording 26 consisting of an audio track (Audio 2) and a video track (Video 2). The standalone microphone 20 captured a single audio recording 27 (Audio 4) that was terminated before the end of the event. As explained in detail below in connection with FIG. 2B, the various audio and video tracks can be combined to create an example composite video 30 by creating a master audio track consisting of the Audio 4 track and a terminal sub-track portion 31 of the Audio 3 track 24, force-aligning a master transcript of the master audio track to the master audio track, and subsequently individually force-aligning the Video 1 track, the Video 2 track, and the Video 3 sub-track to the master transcript.

FIG. 2B shows an example process of combining multiple media sources into a single composite multi-media file.

Source media recordings (also referred to herein as source media files, clips, or tracks) are obtained (FIG. 2B, step 32). The source media recordings may be selected from multiple audio and video recordings of the same event, as shown in FIGS. 1 and 2A. Alternatively, the source media files may be recordings of multiple events. In the example illustrated in FIG. 2A, the source media recordings are the two video recordings 22 and 24 captured by camera 16, the video recording 26 captured by video camera 18, and the audio recording 27 captured by the standalone microphone 20.

A master audio track is created from one or more audio recordings that are obtained from the source media files (FIG. 2B, step 34). In some examples, a single recording (e.g., audio recording) from one device (e.g., Kyle's iPhone) is used as the master audio track. In other examples, a master audio track is created by concatenating multiple audio recordings into a sequence. In general, the sequence of audio recordings can be specified in a variety of different ways. In some examples, the sequence of audio recordings can be specified by the order in which the source media files are listed in a graphical user interface. In some examples, the user optionally can specify for each audio recording a rank or other criterion that dictates a precedence for the automated inclusion of one audio recording over other audio recordings that overlap a given interval of the master audio track. In some examples, the source media selection criterion corresponds to preferentially selecting source media captured by higher quality recording devices over lower quality recording devices. In some examples, the source media selection criterion corresponds to selecting source media (e.g., audio and/or video) associated with a person who currently is speaking.

A transcription of the master audio track is procured (FIG. 2B, step 36). In some examples, the master audio track is divided into a plurality of audio segments that are sent to a transcription service to be transcribed. Professional transcribers or automated machine learning based audio transcription systems may be used to transcribe the audio segments. In some examples, the master audio track is divided into respective overlapping audio segments, each of which is padded at one or both ends with respective audio content that overlaps one or both of the preceding and successive audio segments in the sequence. After the individual audio segments have been transcribed, the transcription service can return transcripts of the individual audio segments of the master audio track.

Each audio segment transcript is force-aligned to the master audio track to produce a master transcript of language elements (e.g., words of phonemes) that are associated with respective time coding (FIG. 2B, block 38). In this process, a sequence of one or more independent transcriptions of audio recordings is force-aligned to the master audio track.

As explained above, “forced alignment” is the process of determining, for each language element (e.g., word or phoneme) of a transcript, the time interval (e.g., start and end times) in the corresponding audio recording containing the spoken text of the language element. In some examples, the force aligner component of the Gentle open source project (see https://lowerquality.com/gentle) is used to generate the time coding data for aligning the master transcript to the master audio track. In some embodiments, the Gentle force aligner includes a forward-pass speech recognition stage that uses 10 ms “frames” for phoneme prediction (in a hidden Markov model), and this timing data can be extracted along with the transcription results. The speech recognition stage has an explicit acoustic and language-modeling pipeline that allows for extracting accurate intermediate data-structures, such as frame-level timing. In operation, the speech recognition stage generates language elements recognized in the master audio track and times at which the recognized language elements occur in the master audio track. The recognized language elements in the master audio track are compared with the language elements in the individual transcripts to identify times at which one or more language elements in the transcripts occur in the master audio track. The identified times then are used to align a portion of the transcript with a corresponding portion of the master audio track. Other types of force aligners may be used to align the master transcript to the master audio track.

After the time-coded master transcript is produced (FIG. 2B, block 38), one or more other source media recordings can be force-aligned to the master transcript (FIG. 2B, block 40). In this process, a force aligner (e.g., the Gentle force aligner) automatically will force-align the audio tracks in the other source media recordings to corresponding regions of text in the master transcript. In this process, every time an audio track of a media recording (e.g., a video recording) has audio data at particular time points in the master transcript, the force aligner splices in the media content (e.g., a video track of a video clip) from the recorded media track to the corresponding time points in the master transcript with the correct timing offset. The result of this process is a precise (e.g., phoneme level) timing alignment between the master transcript and the other source media (e.g., the video track of the video clip).

In some examples, video tracks are captured at the same time by different cameras that are focused on different respective speakers. In some of these examples, the force aligner splices in video content that is selected based on speaker labels associated with the master transcript. For example, the force aligner splices in a first video sub-track during times when a first speaker is speaking and slices in a second video sub-track during times when a second speaker is speaking, where the times when the different speakers are speaking are determined from the speaker labels and the time coding in the master track.

Thus, the composite video 30 shown in FIG. 2A is created by force-aligning the Video 1 track, the Video 2 track, and the Video 3 sub-track to a master transcript with time coding obtained in the process of force-aligning the video tracks to the master audio track consisting of the Audio 4 track concatenated with the Audio 3 sub-track (i.e., the end portion of the Audio 3 track).

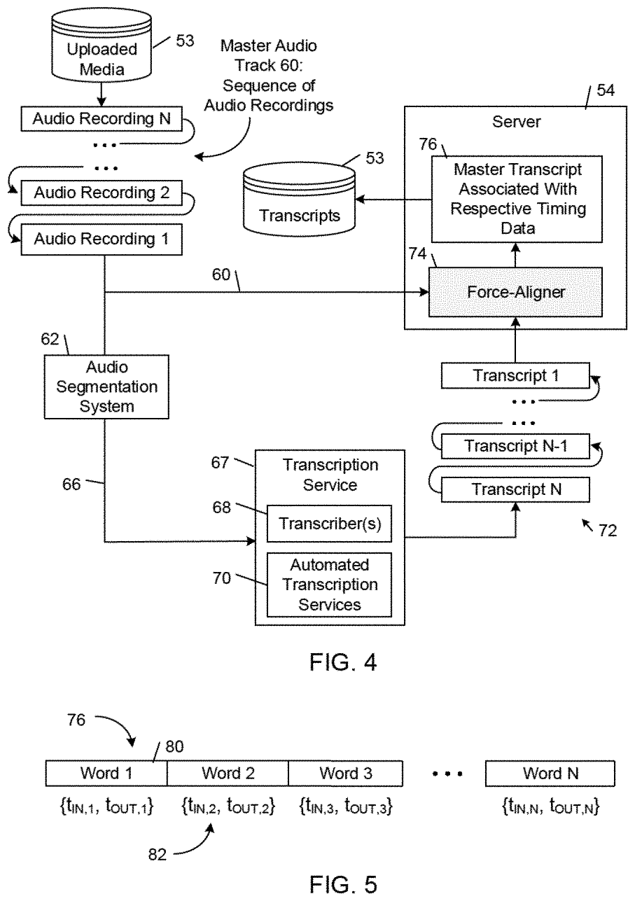

FIG. 3 shows a block diagram of an example system 50 for procuring transcripts of one or more source media 52 that include verbal content (e.g., speech), and force-aligning the one or more transcripts to a master audio track to create a force-aligned master transcript in a transcripts database 53. FIG. 4 shows an example flow diagram of an example process performed by the system 50.

Source media 52 may be uploaded to a server 54 from a variety of sources, including volatile and non-volatile memory, flash drives, computers, recording devices 56, such as video cameras, audio recorders, and mobile phones, and online resources 58, such as Google Drive, Dropbox, and YouTube. Typically, a client uploads a set of media files 51 to the server 54, which copies the audio tracks of the uploaded media files and arranges them into a sequence specified by the user to create a master audio track 60. The master audio track 60 is processed by an audio segmentation system 62, which divides the master audio track 60 into a sequence of audio segments 64, which typically have a uniform length (e.g., 1 minute to five minutes) and may or may not have padding (e.g., beginning and/or ending portions that overlap with adjacent audio segments). In the illustrated example, the audio segments 64 are stored in an audio segment database 66, where they are associated with identifying information, including, for example, a client name, a project name, and a date and time.

In some examples, the audio segments 66 are transcribed by a transcription service 67. A plurality of professional transcribers 68 typically work in parallel to transcribe the audio segments 60 that are divided from a single transcript. In other examples, one or more automated machine learning based audio transcription systems 70 are used to transcribe the audio segments 66 (see FIG. 4). In the process of transcribing the audio segments 66, respective sections of the transcribed text are labeled with information identifying the respective speaker of each section of text. After the audio segments 66 have been transcribed, the transcripts may be edited and proofread by, for example, a professional editor before the transcripts 72 are transferred to the server 54.

After the transcripts 72 of the audio segments 66 have been transferred to the server 54, they may be stored in a transcript database 73. The transcripts are individually force-aligned to the master audio track 60 by a force aligner 74 to produce a master transcript 76 of time-coded language elements (e.g., words or phonemes), which may be stored in a master transcript database 78 (see FIG. 4). In some examples, the force aligner component of the Gentle open source project (see https://lowerquality.com/gentle) is used to generate the time coding data for force-aligning the master transcript segments 72 to the master audio track 60, as explained in detail above.

FIG. 5 shows an example of the master transcript 76 that includes a sequence of words 80 (e.g., Word 1, Word 2, Word 3, . . . Word N) each of which is associated with time coding data that enables other media recordings to be force-aligned to the master transcript. In some examples, each of the words in the master transcript is associated with a respective time interval 82 (e.g., {t_{IN,1}, t_{OUT,1}}, . . . {t_{IN,N}, t_{OUT,N}}) during which the corresponding word was spoken in the master audio track 60. A force aligner (e.g., the force aligner component of the Gentle open source project) is used to force-align an audio track in another media file to the master transcript and use the resulting forced-alignment time coding to splice-in a corresponding non-audio track (e.g., a video track) to the corresponding time points in the master track with the correct offset.

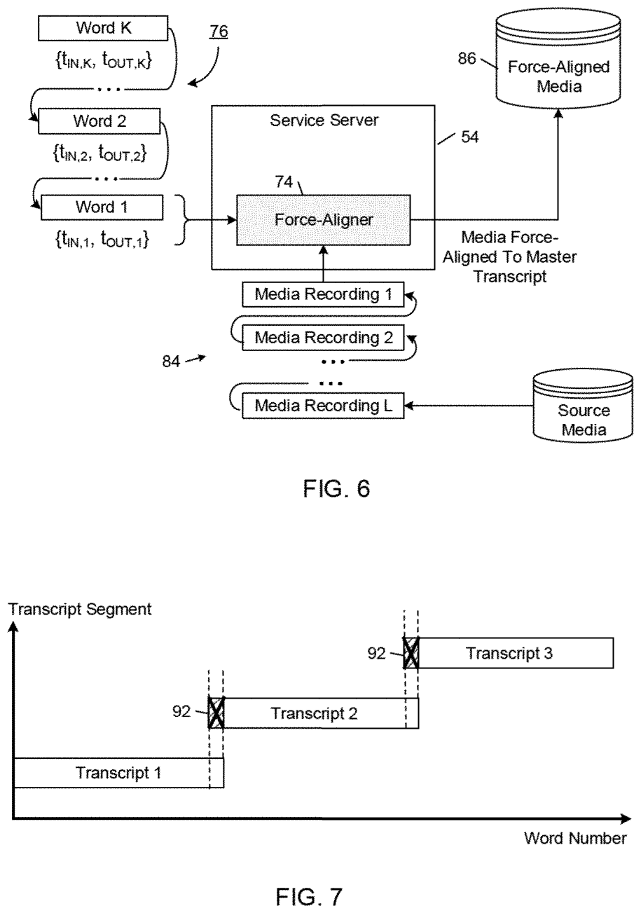

FIG. 6 shows an example process of force-aligning a sequence of recorded media tracks to the master transcript 76. In this process, every time a media track of a multimedia recording 84 has audio data at particular time points in the master transcript, the force aligner 74 splices the media from the media track of the multimedia recording into the corresponding time points in the master transcript 76 with the correct timing offset. The sequence of media tracks may be, for example, the sequence of video tracks consisting of Video 1, Video 2, and Video 3 shown in FIG. 2A. In this example, every time an audio track of one of the video recordings has audio data at certain time points in the master transcript, the force aligner 74 splices the corresponding video into the corresponding time points in the master transcript with the correct timing offset. The resulting force-aligned media typically is stored in a database 86.

In some examples, the master audio track is divided into audio segments without any overlapping padding. In these examples, the force aligner starts force-aligning each master transcript segment to the master audio track at the beginning of each transcript segment.

As explained above, however, the lack of audio padding at the start and end portions of each audio segment can prevent transcribers from comprehending the speech to be transcribed, increasing the likelihood of transcription errors. Transcription accuracy can be improved by ensuring that transcribers are given sufficient audio context to comprehend the speech to be transcribed. In some examples, the master audio track is divided into audio segments with respective audio content that overlaps the audio content in the preceding and/or successive audio segments in the master audio track. In these examples, to avoid duplicating words, the force-aligner automatically starts force-aligning each master transcript segment to the master audio track at a time point in the master audio track that is offset from the beginning and/or end of the master transcript segment by an amount corresponding to the known length of the padding.

FIG. 7 shows an example sequence of overlapping transcripts of a series of successive master audio segments (not shown), each of which includes a beginning padding portion 90, 92 with audio content that overlaps a corresponding terminal portion of the immediately preceding master audio segment. In this example, to avoid duplicating words, the force aligner skips the initial padding portion 90, 92 of each segment transcript before proceeding with the forced-alignment of the next successive segment transcript to the master audio track.

Correcting Audio Drift

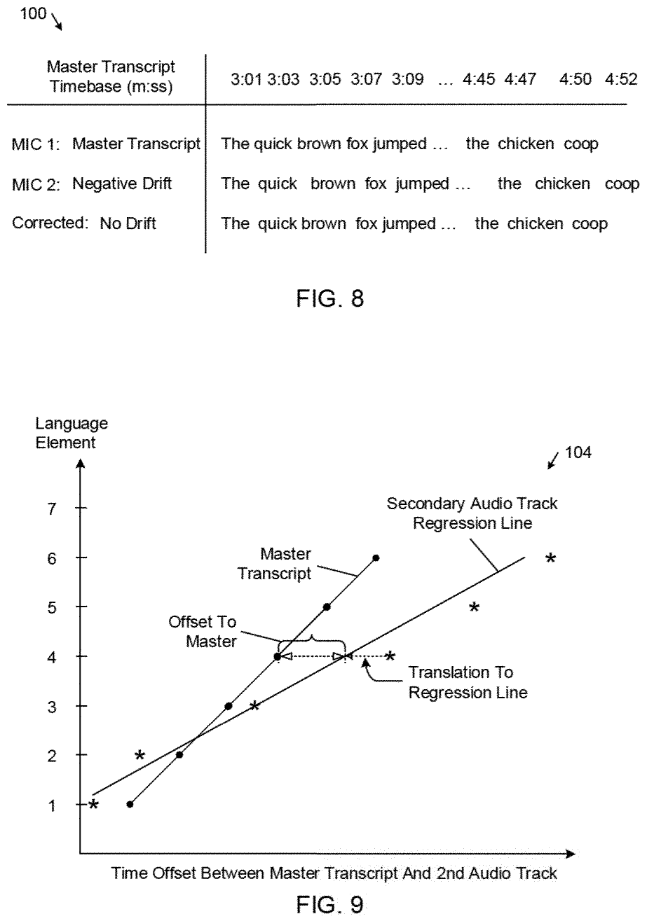

Some microphones exhibit imperfect timing, which results in the loss of synchronization between recordings over time. Referring to FIG. 8, a table 100 shows a first sequence of words captured by a primary microphone (MIC 1), which may be, for example, implemented by the standalone microphone 20 in the exemplary use case show in FIG. 1, and a second sequence of words captured by a secondary microphone (MIC 2), which may be, for example, implemented by a clip-on microphone carried by an operator of the camera 16 in the exemplary use case shown in FIG. 1. The first and second sequences of words captured by the primary and secondary microphones are identical except the second sequence exhibits negative drift over time. There also is a third sequence of words to which corrective offsets have been applied to reduce the drift exhibited in the second sequence of words, where the corrective offsets are determined from the time coding data generated in the process of force-aligning the media track exhibiting drift to the master transcript.

In this example, the audio captured by the primary microphone (MIC 1) is the master audio track, which is transcribed into a sequence of one or more transcripts that are force-aligned to the master audio track to produce the master transcript of language elements and associated timing data. The audio captured by the secondary microphone is force-aligned to the master transcript to produce a set of time offsets between the words in the master transcript and the spoken words in the secondary audio track. As shown in FIG. 8, the secondary audio track exhibits a negative drift relative to the master track that can be computed from the time offsets between the words in the master transcript and the corresponding spoken words in the secondary audio track.

FIG. 9 shows a diagrammatic graph of language element number as a function of time offset for an example master transcript and an example secondary audio track. The master transcript is the reference audio track. The secondary audio track exhibits negative audio drift relative to the master transcript. The audio drift in the secondary audio track can be reduced by calculating a linear best fit line (i.e., linear regression line) through the secondary audio track data and calculating a respective time offset from the master transcript value for each language element number. The time offset to master transcript values can be calculated by translating the time offset for each language element in the secondary audio track to the linear best fit line, and computing the offset to master transcript for the language element from the difference between the time offset between the translated time offset on the linear best fit line and the time offset for the corresponding language element in the master transcript.

The computed time offsets to master transcript can be used to splice in any media that is synchronized with the secondary audio track. In some examples, the linear best fit is used to determine the correct timing offsets for splicing in a video track synchronized with the secondary audio track. In some examples, the linear best fit is used to determine the correct time offsets in realtime, subject to a maximum allowable drift threshold. For example, when patching in a video track that exhibits drift relative to the master transcript, frames in the video track can be skipped, duplicated, or deleted, or the timing of the video frames can be adjusted to reduce drift to a level that maintains the drift within the allowable drift threshold. For example, linear interpolation can be added throughout an entire media chunk to realign the timing data to reduce the drift. In other examples, a video track that exhibits drift can be divided into a number of different parts each of which is force-aligned to the master transcript and spliced in separately with a respective offset that ties each part to the master audio track.

The approaches described above are robust and work under a variety of adverse conditions, as a result of the very high accuracy of the process of force-aligning media tracks to the master transcript. For example, even if the microphones are very different (e.g., a clip-on microphone that records only one person's voice and another microphone that records audio from everything in the room), there typically will be enough words that are received by the clip-on microphone that timing data can be obtained and used to correct the drift. An advantage of this approach is that it accommodates a large disparity in microphone drift and audio quality because anything that is legible for voice would work and there is no need to maintain tone or use all of the audio channels (e.g., the audio channels could be highly directional). In this way, the approach of force-aligning all channels to the timing data associated with the master transcript offers many advantages over using acoustic signals directly. Even if the transcript is imperfect (e.g., an automated machine transcript), it is likely to be good enough to force-align audio tracks to the master transcript. For this particular application a verbatim transcript is not required. The transcript only needs to have enough words and timing data for the force aligner to anchor into it.

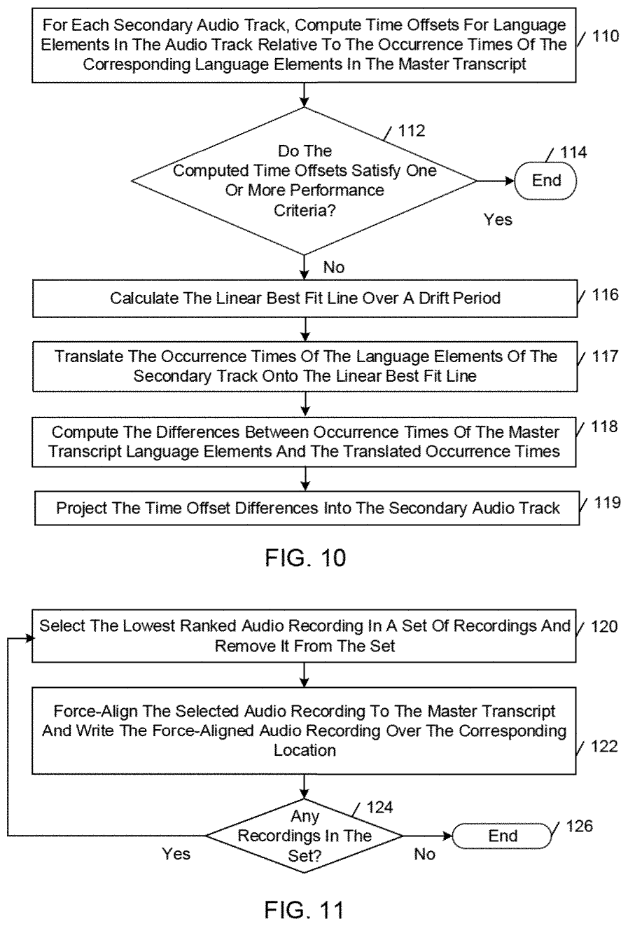

FIG. 10 shows an example process for reducing drift in a secondary audio track relative to the primary audio track from which the master transcript is derived. For each secondary audio track, time offsets for language elements (e.g., words or phonemes) in the secondary audio track relative to the corresponding language elements in the master transcript are computed (FIG. 10, block 110). In some examples, the start-time offset and/or the end-time offset from the occurrence time of the corresponding language element in the master transcript is computed for each language element in the secondary audio track. In other examples, the start-time offsets and/or the end-time offsets are computed for a sample of the language elements in the secondary track. If the computed time offsets satisfy one or more performance criteria, the process ends (FIG. 10, block 114). An example performance criterion is whether the time offset data (or a statistical measure derived therefrom) for the secondary audio track is less than a maximum drift threshold (FIG. 10, block 112), in which case the process ends (FIG. 10, block 114). Otherwise, a linear best fit line (i.e., a linear regression line) is calculated from the time offsets over the drift period, typically from the start-time of the first language element to the end-time of the last language element in the secondary track (FIG. 10, block 116). The occurrence times of the language elements of the secondary track are translated onto the linear best fit line (FIG. 10, block 117). The time offset differences between the occurrence times of the language elements in the master transcript and the translated occurrence times of the corresponding language elements in the secondary audio track are computed (FIG. 10, block 118). The computed time offset differences are projected into the secondary audio track to reduce the drift in the secondary audio track (FIG. 10, block 119).

As explained above, in some examples, a user optionally can specify for each audio recording a rank that will dictate precedence for the automated inclusion of one audio recording over other audio recordings that overlap a given interval in the master audio track. This feature may be useful in scenarios in which there are gaps in the primary audio recording captured by a dedicated high-quality microphone. In such cases, the gap can be filled-in with audio data selected based on the user designated ranking of the one or more microphones that recorded audio content overlapping the gap in coverage. In some examples, the ranking corresponds to designated quality levels of the recording devices used to capture the audio recordings.

FIG. 11 shows a method of incorporating audio tracks into a master audio track based on a set of ranked audio recordings. In accordance with this method, the server 54 selects the lowest ranked audio recording in a set of recordings and removes it from the set (FIG. 11, block 120). The server 54 uses a force aligner to force-align the selected audio recording to the master transcript and write the force-aligned audio recording over the corresponding location (FIG. 11, block 122). In some examples, the force-aligned audio recordings are written to an audio buffer. If there are more ranked audio recordings in the set (FIG. 11, block 124), the process continues with the section of the lowest ranked audio recording in the set of recordings (FIG. 11, block 120). Otherwise, if there are no more ranked audio recordings in the set (FIG. 11, block 124), the method ends (FIG. 11, block 126).

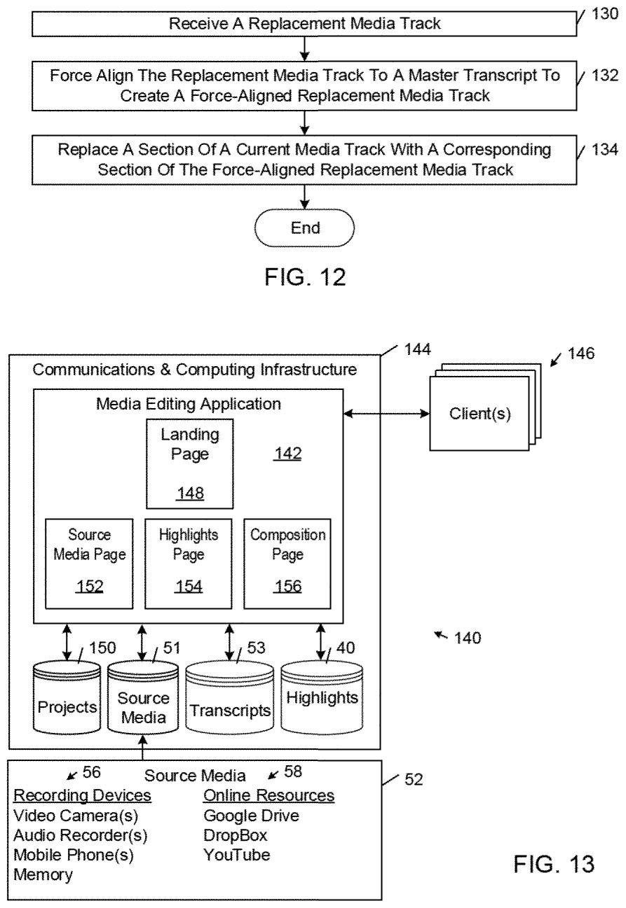

FIG. 12 shows a method of replacing a section of a current media track with a corresponding section of a force-aligned replacement media track. In accordance with this method, the server 54 receives a replacement media track (FIG. 12, block 130). The server 54 applies a force aligner to force-align the replacement media track to the master transcript (FIG. 12, block 132). The section of the current media track is replaced by a corresponding section of the force-aligned replacement media track (FIG. 12, block 134).

In an example, the current media track is a master audio track and the replacement media track is a higher quality audio track that includes a section that overlaps the master audio track. In another example, the current media track is a video track of a first speaker and the replacement media track is a video track of a second speaker that is selected based on a speaker label associated with the master transcript.

Editing Application

As explained above, even with transcripts that contain accurate timing data (e.g., time codes or offsets to master transcript timing data) that are synchronized with audio and video recordings, finding the best media content to use for a project involving many sources and many hours of recordings can be difficult and time-consuming. The systems and methods described herein provide the search and categorization tools needed to rapidly parse source media recordings using highlights, make connections (thematic or otherwise) between highlights, and combine highlights into a coherent and focused multimedia file. The ease and precision of creating a highlight can be the basis for notes, comments, discussion, and content discovery. In addition, these systems and methods support collaborative editing within projects, where users who are concurrently on the system can immediately see and respond to changes made and suggested by other users. In this way, these systems and methods can substantially reduce the burden of identifying the best media content, discovering themes, and making connections between seemingly disparate source media.

FIG. 13 shows an example media editing service 140 that is implemented as a multi-user, collaborative, web-application 142 with role-based access control. It is structured with a collection of source media 51 in projects 150. Each source media 51 may be concatenated from multiple recordings. Each project 150 may have a different set of collaborators, with different permission levels (e.g., administrator, editor, viewer). Multiple users may be on the site simultaneously, and will see the changes made by others instantaneously.

The media editing web-application 142 provides media editing services to remote users in the context of a network communications and computing infrastructure environment 144. Clients may access the web-application from a variety of different client devices 146, including desktop computers, laptop computers, tablet computers, mobile phones and other mobile clients. Users access the media editing service 140 by logging into the web site. In one example, the landing page 148 displays a set of projects 150 that are associated with the user. As explained in detail below, each project 150 may be edited and refined in a recursive process flow between different sections of the web-application that facilitate notes, comments, discussion, and content discovery, and enables users to quickly identify the most salient media content, discover themes, and make connections between highlights. In the illustrated embodiment, the main sections of the web-application are a source media page 152, a highlights page 154, and a composition page 156.

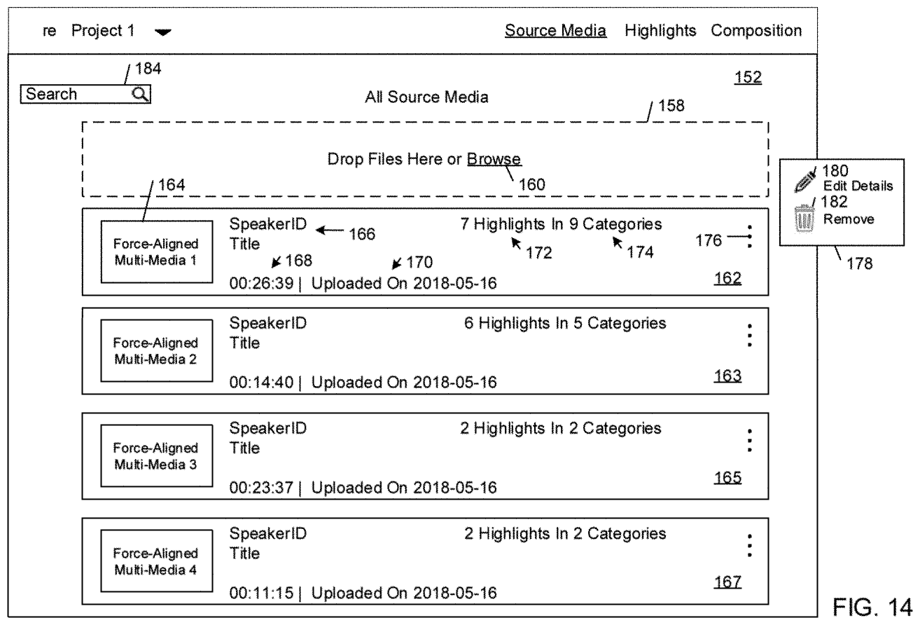

The user opens a project 150 by selecting a project from a set of projects that is associated with the user. This takes the user to the source media page 152 shown in FIG. 14. The source media page 152 enables the user to upload source media 52 into the current project, edit a respective label 162 for each of the uploaded source media 52, and remove a source media file 52 from the current project.

The source media page 152 includes an upload region 158 that enables a user to upload source media into the current project, either by dragging and dropping a graphical representation of the source media into the upload box 158 or by selecting the “Browse” link 160, which brings up an interface for specifying the source media to upload into the project. Any user in a project may upload source media for the project. Each source media may include multiple audio and video files. As explained above in connection with FIG. 13, a variety of different source media 52 may be uploaded to the media editing web-application 142 from a variety of different media storage devices, platforms, and network services, including any type of volatile and non-volatile memory, flash drives, computers, recording devices 56, such as video cameras, audio recorders, and mobile phones, and online media resources 58, such as Google Drive, Dropbox, and YouTube.

After the user has uploaded source media to the project, the service server 54 may process the uploaded source media, as described above in connection with FIG. 3. In some embodiments, a client uploads a set of one or more media files 51 to the server 54, which copies the audio tracks of the uploaded media files 51 and arranges them into a sequence specified by the user to create a master audio track 60. The master audio track 60 is transcribed by a transcription service 67. As explained above, this process may involve dividing the media files into a set of overlapping small chunks that are sent to different transcriptionists or one or more automated transcription systems. This allows for a long file to be professionally transcribed very quickly. When all of the transcriptionists have finished with their respective transcript chunks, each transcript is automatically force aligned to a master audio track that is derived from the sequence specified by the user. In this process, the forced alignment timing data is used to resolve the overlapping boundaries between the transcript chunks. In this way, even if a word is cut off or there isn't enough context at the beginning of a chunk, the system can patch together a seamless transcript. The result is a single transcript with word-level, 10 ms accuracy or better, timing data. After the master audio track 60 is transcribed and force-aligned to the master audio track, the resulting master transcript 76 of time-coded language elements (e.g., words or phonemes) may be stored in the transcripts database 53 (see FIG. 4).

Referring back to FIG. 14, in the illustrated embodiment, each of the uploaded source media files 51 is associated with a respective source media panel 162, 163, 165, 167 that includes a number of data fields that characterize features of the corresponding source media file. In some examples, each source media panel 162 is an object that includes links to an image 164 of the first frame of the corresponding source media file, a caption 166 that describes aspects of the subject mater of the corresponding source media file, an indication 168 of the length of the corresponding source media file, a date 170 that the corresponding source media file was uploaded into the project, and respective counts of the number of highlights 172 and categories 174 that are associated with the corresponding source media file. In some use cases, the number of highlights associated with a source media file may reflect the salience of the source media file to the project, and the number of categories associated with the source media file may indicate the breath of the themes that are relevant to the source media file.

In some examples, the media editing application 142 is configured to automatically populate the fields of each source media panel with metadata that is extracted from the corresponding source media file 51. In other examples, the user may manually enter the meta data into the fields of each source media panel 162, 163, 165, 167.

Each source media panel 162, 163, 165, 167 also includes a respective graphical interface element 176 that brings up an edit window 178 that provides access to an edit tool 180 that allows a user to edit the caption of the source media panel 162 and a remove tool 182 that allows a user to delete the corresponding source media from the project.

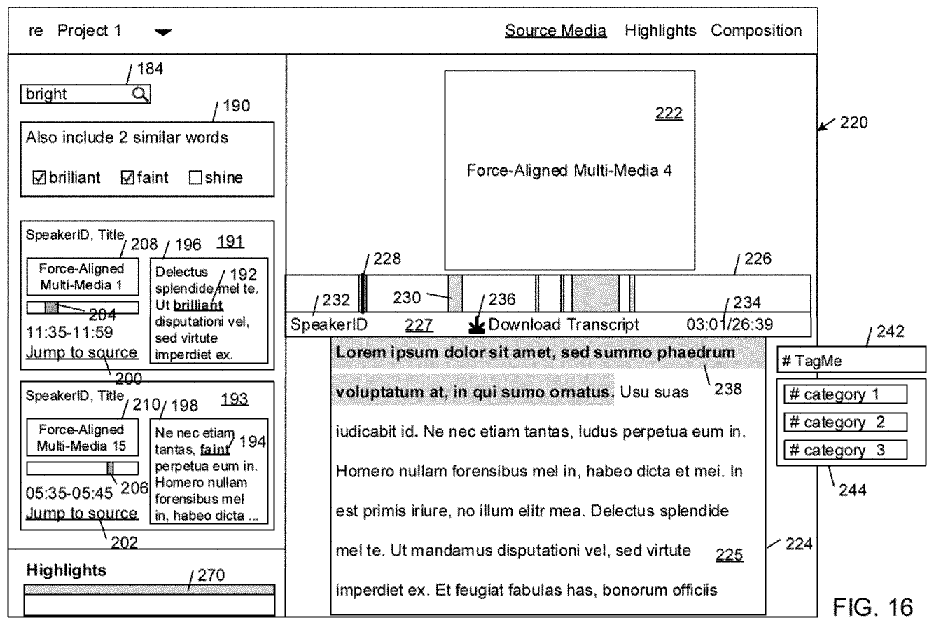

The image 164 of the first frame of the corresponding source media file is associated with a link that takes the user to a source media highlighting interface 220 that enables the user to create one or more highlights of the corresponding source media as described below in connection with FIG. 16.

The source media page 152 also includes a search interface box 184 for inputting search terms to a search engine of the media editing web-application 142 that can find results in the text-based elements (e.g., words) in a project, including, for example, one or more of the transcripts, source media metadata, highlights, and comments. In some embodiments, the search engine operates in two modes: a basic word search mode, and an extended search mode.

The basic word search mode returns exact word or phrase matches between the input search words and the words associated with the current project. In some examples, the search words that are associated with the current project are the set of words in a corpus that includes the words in the intersection between the vocabulary of words in a dictionary and the words in the current project.

After performing the basic word search, the user has the option to extend the search to semantically related words in the dictionary. Therefore, in addition to finding exact-word matches, the search engine is able to find semantically-related results, using a word embedding model. In an embodiment of this process, only the vectors of words contained within the project are considered when computing a distance from a search term. In some examples, the search engine identifies terms that are similar to the input search terms using a word embedding model that maps search terms to word vectors in a word vector space. In some examples, the cosine similarity is used as the measure of similarity between two word vectors. The extended search results then are joined with the exact word match results, if any. In some use cases, this approach allows the user to isolate all conversational segments relating to a theme of interest, and navigate exactly to the relevant part of the video based on the precise timing alignment between the video and the words in the master transcript.

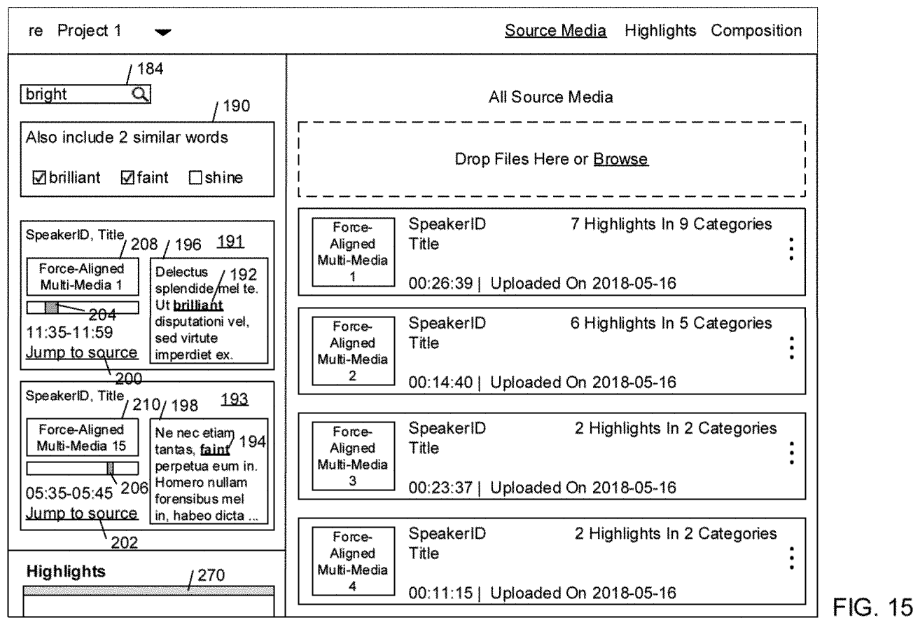

FIG. 15 shows an example in which the user's initial basic word search term (i.e., “bright”) did not result in any exact word matches. In response, the search engine automatically expanded the search to include semantically similar words from the corpus and presented the similar words (i.e., “brilliant,” “faint,” and “shine”) for selection by the user in the expanded search pane 190. The user then broadened the initial search results by selecting the similar words “brilliant” and “faint,” which are within the threshold distance of the input search term “bright.” In response to the user's selection of the two similar words, the media editing web-application 142 presents two search results panels 191, 193 each of which includes the matching transcript text 192, 194 (i.e., the words “brilliant” and “faint”), the surrounding text 196, 198 (e.g., bounded by paragraph or speaker change), links 200, 202 to the full transcript, the locations 204, 206 of the video frame intervals that are associated with the same time stamps as the text 196, 198 surrounding the selected similar words, and the first video frames 208, 210 of the corresponding intervals.

In the example shown in FIG. 15, each of the search results 191, 193 is displayed within the context of other words and phrases as they occur in time throughout the transcript. In some examples, the searched words 192, 193 are displayed with emphasis (e.g., underlined or bold font) within their original context of the spoken word and linked 200, 202 to the original source in time. Even though they may differ in time and/or context, the semantically-related search results 191, 193 are presented together in the same interface to a enable discovery of new relationships and themes between seemingly disparate subject matter.

Referring to FIG. 16, selecting one of the “Jump to source” links 200, 202 in the search results panels 191, 193 opens a media source highlighting interface 220 in the context of the search interface (i.e., the search interface box 184, the expanded search pane 190, and the search results panels 191, 193) in the same state that it was in before the “Jump to source” link was selected. This allows the user to rapidly evaluate the relevance and quality of the search terms in their respective contexts and decide whether or not to create a highlight of the associated media source.

The media source highlighting interface 220 includes a media player pane 222 for playing video content of the selected media source and a transcript pane 224 for displaying the corresponding synchronized transcript 225 of the selected media source. The media source highlighting interface 220 also includes a progress bar 226 that shows the currently displayed frame with a dark line 228, and indicates the locations of respective highlights 230 in the media source with shaded intervals 230 of the progress bar 226. Below the progress bar 226 is header bar 227 that shows the name 232 (SpeakerID) of the current speaker at the current location in the transcript, the current playback time 234 in the media source, and a “Download Transcript” Button 236 that enables the user to download a text document that contains the transcript 225 of the selected source media.

The media source highlighting interface 220 enables a user to create highlights of the selected source media. A highlight is an object that includes text copied from a transcript of a media source and the start and end time codes of the copied text. In some examples, the user creates a highlight by selecting text 238 in the transcript 225 displayed in the transcript pane 224 of the media source highlighting interface 220. The user may use any of a wide variety of input devices to select text in a transcript to create a highlight, including a computer mouse or track pad. In response to the user's selection of the text 238 shown in FIG. 16, for example, the web-application 142 opens a pop-up input box 242 that prompts the user to enter a category for the highlight. When the user clicks on the input box 242, a drop down list 244 of existing categories appears. The user can input a new category for the highlight in the input box 242 or can select an existing category for the highlight from the drop down list 244.

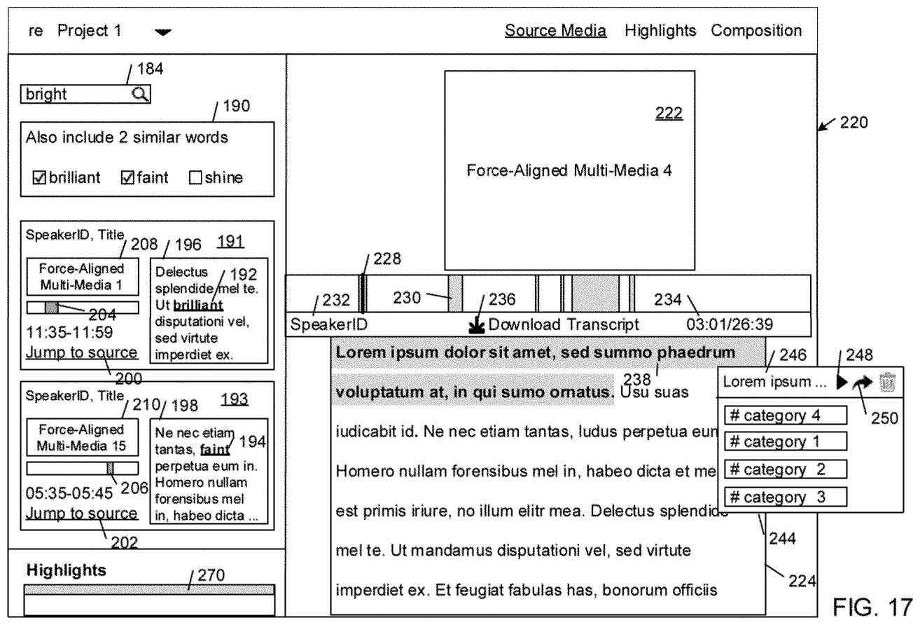

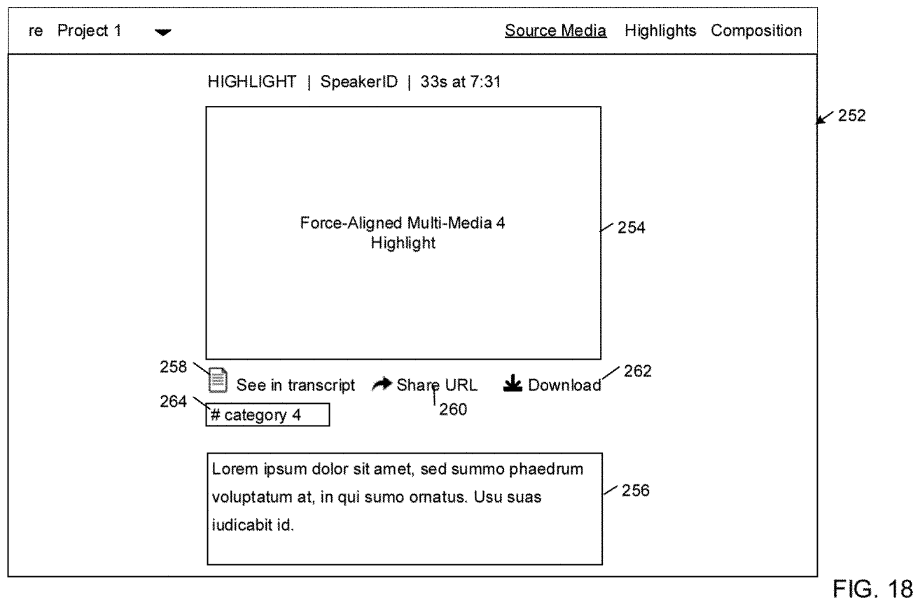

Referring to FIG. 17, after the user has selected a category (i.e., “category 4”) for the new highlight, the web-application 142 creates the highlight and presents the beginning text of the highlight in a top header bar 246, along with a playback control 248 and breakout control 250. The playback control 248 allows the user to playback the new highlight in the media source highlighting interface 220. In response to user selection of the playback control 248, the media player plays the portion of the video or audio media file corresponding to the transcript text 238 of the new highlight and, at the same time, the system displays the current word in the transcript that is currently being spoken in the audio with emphasis (e.g., with bold or different colored font) in order to guide the user through the transcript synchronously with the playback of the corresponding audio and/or video content.

Referring to FIG. 18, when the user selects the breakout control 250 shown in FIG. 17, the web-application 142 opens a highlight page 252 for playing back the highlight. The highlight page 252 includes a media player pane 254 for playing video and/or audio content of the new highlight. At the same time, the web-application 142 highlights the current word of the highlight in the transcript pane 256 being spoken in the audio to synchronously guide the user through the highlight transcript. The highlight page 252 also includes a transcript control 258 that takes the user back to the media source highlighting interface 220. A Share URL control 260 saves a copy of the URL of the highlight page 252 in memory so that it can be readily shared with one or more other users. A download transcript control 262 enables the user to download a full resolution video of the highlight. A category tag 264 is associated with a link that takes the user to the corresponding category in the highlights page 154.

In this way, the user can scroll through the media sources that are discovered in the search, playback individual ones of the source media files and their respective transcripts, and save tagged highlights of the source media in the search results without having to leave the current interface. At a high level, the fact that this textual search takes the user back to the primary source video is both valuable and unusual, due to the capacity of audio/video media to contain additional sentiment information that's not apparent in the transcript alone.

Referring back to FIG. 17, after a highlight is created for a particular source media file, the highlight is displayed in a respective highlight pane in a Highlights section 270 of the source media page. In some embodiments, each highlight pane in the Highlights section 270 includes: the length of the highlight and its start time in the corresponding media source; a link to the corresponding media source; a copy of the text of the highlight; and one or more category descriptors linked to respective ones of the categories in the Highlights page 154. The highlight panes are listed in reverse chronological order of the creation times of the associated highlights, with the most recently created highlights at the top of the list.

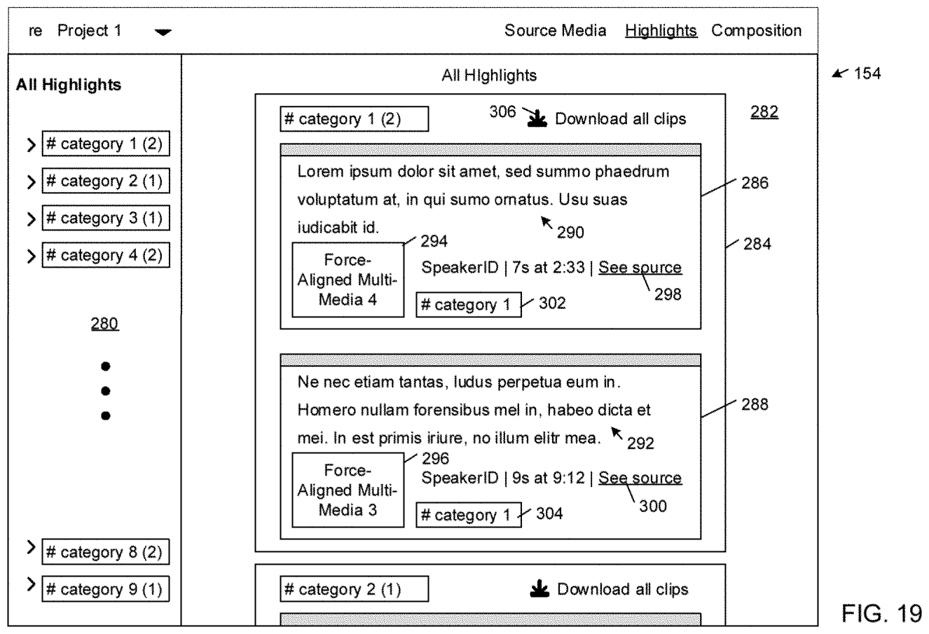

FIG. 19 shows an embodiment of the highlights page 154 that includes a categories section 280 and a highlights section 282. The categories section 280 includes a list of all the categories that are associated with the project. In one embodiment, the categories are listed alphabetically by category descriptor (e.g., “category 1”). Each category in the categories section 280 also includes a respective count of the number of highlights that are tagged with the respective category. The highlights section 282 shows a list of of the highlights in the project, grouped by category. In response to the user's selection of one of the categories in the categories section 280, the web-application 142 automatically scrolls through the list of groups of highlights to the location in the list that corresponds to the group of highlights associated with the selected category (e.g., group 284 corresponding to “category 1”). The group 284 corresponding to highlight category 1 includes a first highlight window 286 and a second highlight window 288. Each window 286, 288 includes the respective highlight text 290, 292, a respective media player for playing back the associated media file clip 294, 296, identifying information about the speaker (SpeakerID), the clip length and the starting location of the clip in the corresponding source media file (e.g., 7 seconds at 2:33), a respective 298, 300 link to the corresponding source media, and a respective category descriptor 302, 304. Selecting the SpeakerID link or the clip location link takes the user to a highlights page 252 where the user can playback the highlight and perform other operations relating to the highlight (see FIG. 18). Each group of highlights also includes a download button 306 that allows the user to download all of the media file clips 294, 296 in the corresponding group 284 to the user's computing device for playback or other purposes.

In an exemplary process flow, the user performs an iterative process that enables the user to quickly and efficiently isolate all conversational segments relating to a theme of interest, and navigate exactly to the relevant part of the video. In such a process, the user starts off by searching for a word or phrase. The user examines the returned clips for relevance. The user then extends or broadens the search for related and suggested search terms. The user tags multiple clips with relevant themes of categories of interest. The user then edits individual clips to highlight a particular theme. The user can browse the clips and start playing the video at the exact point when the theme of interest begins. Now the user is ready to compile a single video for export consisting of segments related to the theme of interest.

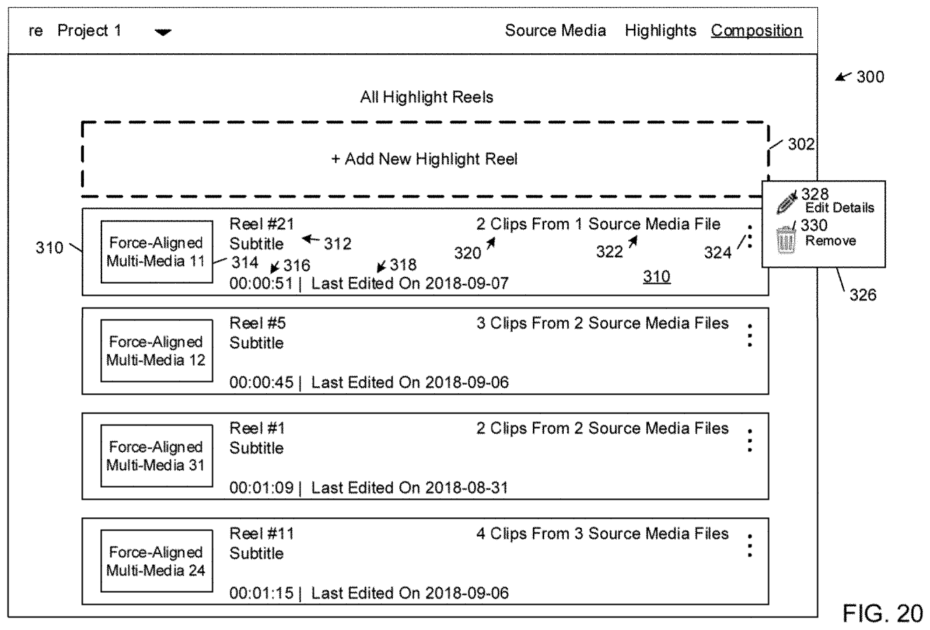

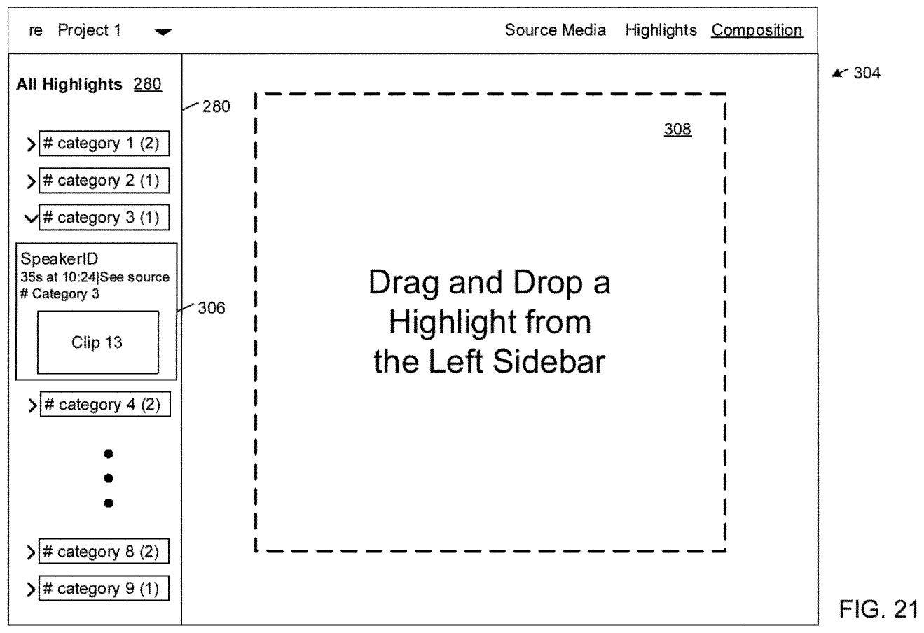

FIG. 20 shows an example of a media composition landing page 300 that enables a user to compose a new highlight reel or edit an existing highlight reel. A highlight reel is a multimedia file that composed of one or more media source files that can be concatenated together in any order and edited using a text-based audio and video editing interface. The user can add a new highlight reel by selecting the Add New Highlight Reel interface region 302. This takes the user to a highlight selection interface 304 shown in FIG. 21.

Referring to FIG. 21, the highlight selection interface 304 allows the user to select an individual highlight or a group of highlights assigned to the same category. For example, the user can toggle the rightward facing arrow for category 3 to reveal the set of individual highlights grouped under category 3. The user can select the desired individual highlight 306 and drag it from the left sidebar and drop it into the region 308 to add the selected individual highlight to the new reel. In addition, the user also may select a group of highlights in the same category into the region 308 by selecting the corresponding category tag (e.g., # category 1) and dragging it from the left sidebar and dropping it into the region 308.

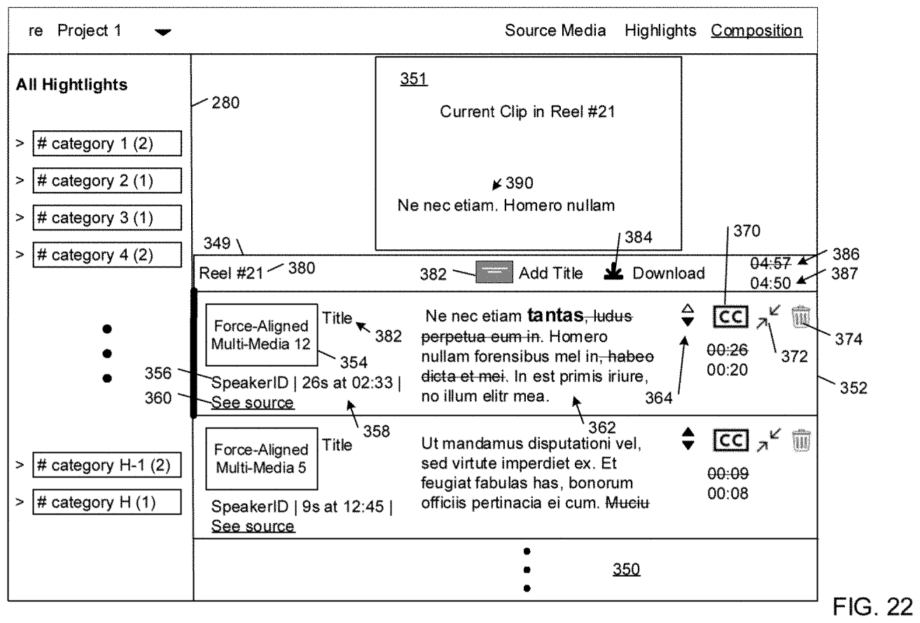

Referring back to FIG. 20, in the illustrated embodiment, the user also can choose to edit an existing reel by selecting its reels panel 310. Each reels panel 310 is an object that includes identifying information and a link to a main reels editing page shown in FIG. 22. The identifying information includes a caption 312 that describes aspects of the subject mater of the corresponding reels multimedia file (e.g., a title and a subtitle), a respective image 314 of the first frame of the corresponding reels multimedia file, an indication 316 of the length of the reels multimedia file, a date 318 that the reels multimedia file was edited, and respective counts of the number of clips 320 and source media files 322 that are associated with the reels multimedia file. Each reels multimedia panel also includes a respective graphical interface element 324 that brings up an edit interface window 326 that provides access to an edit tool 328 that allows a user to edit the caption 312 of the reels panel 310, and a remove tool 330 that allows a user to delete the corresponding reels multimedia file from the project.

Referring to FIG. 22, after selecting an existing reel or selecting one or more source media files for a new reel, the user is taken to the editing interface page where the web-application provides the highlights sidebar 280, a header bar 349, an editing interface 350, and a media playback pane 351.

The highlights sidebar 280 includes all of the highlights in the project, grouped by category. The user can drag and drop individual highlights or all the highlights associated with a selected category into the editing interface 350. An individual highlight or an entire group of highlights can be inserted into any location before, after, or between the any of the highlights currently appearing in the editing interface 350.

The header bar 349 includes a title 380 for the current reel, an Add Title button 380 for editing the title 382 of each selected highlight in the current reel, a download button 384, and indications 386, 387 of the original length of the sequence of media files in the reel and the current length of the sequence of media files in the reel. In response to selection of the download button, all of the highlights are rendered into a single, continuous video, including corresponding edits, title pages, and optional burn-in captions as desired. Each highlight is represented in the editing interface 350 by a respective highlight panel 352. Each highlight panel 352 is an object that includes a respective image 354 of the first frame of the corresponding highlight, the name 356 (SpeakerID) of the speaker appearing in the highlight, indications 358 of the length and location of the highlight in the source media, a link 360 to the source media, the text of the highlight 362, a pair of buttons 364 for moving the associated highlight panel 352 forward or backward in the sequence of highlight panels, a closed captioning button 370 for turning on or off the appearance of closed captioning text in the playback pane 351, a toggle button 372 for expanding or collapsing cut edits in the transcript 362, and a delete button 374 for deleting the highlight and the associated highlight panel from the current reel.

As soon as one or more highlights are dragged and dropped into the editing interface 350, the web-application compiles the highlights into a concatenated sequence of media files. The highlights are played back according to the arrangement of highlights in the highlight panels 352. In one embodiment, the web-application concatenates the sequence of highlight panels 352 in the editing interface 350 from top to bottom. The sequence of media files can be played back by clicking the playback pane 351. Additionally, a Reel can be downloaded as rendered video by selecting the Download button 384. In this process, the web-application packages the concatenated sequence of media files into a single multimedia file.

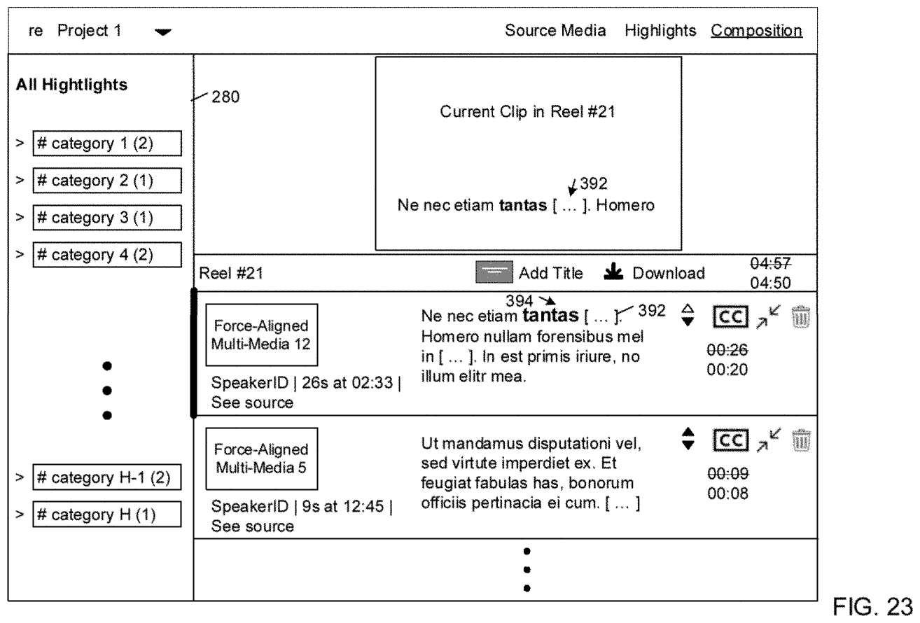

If closed captioning is enabled, closed captioning text 390 will appear in the playback pane 351 synchronized with the words and phrases in the corresponding audio track. In particular, the web-application performs burn-in captioning using forced-alignment timing data so that each word shows up on-screen at the exact moment when it is spoken. In the editing interface 350, words and phrases in the text 362 of the highlight transcripts can be selected and struck out, resulting in a cut in the underlying audio and video multimedia. This allows the user to further refine the highlights to capture the precise themes of interest in the highlight. Indications of the struck out portions may or may not be displayed in the closed captioning or audio portions of the highlight. In the embodiment shown in FIG. 22, the struck out portions of the highlight transcripts are not displayed in the concatenated multimedia file and there is no indication in the closed captioning text 390 that parts of the text and audio have been deleted. In the embodiment shown in FIG. 23, on the other hand, the struck out portions of the highlight transcripts are not displayed in the concatenated multimedia file but there is an indication 392 (i.e., an ellipsis within brackets) in the text that one or more parts of the text and audio have been deleted.

In some embodiments, the user can apply typographical emphasis to one or more words in a highlight transcript, and the web-application will interpret the typographical emphasis as an instruction to automatically apply a media effect that is synchronized with the playback of the composite multimedia file. In the example shown in FIG. 23, the typographical emphasis is the application of bold emphasis to the word “tantas” 394 in the transcript. In response to detection of the bold emphasis, the web application automatically increases the audio volume at the exact same time in the audio track that the bolded word is spoken in the audio and displayed in the transcript text.

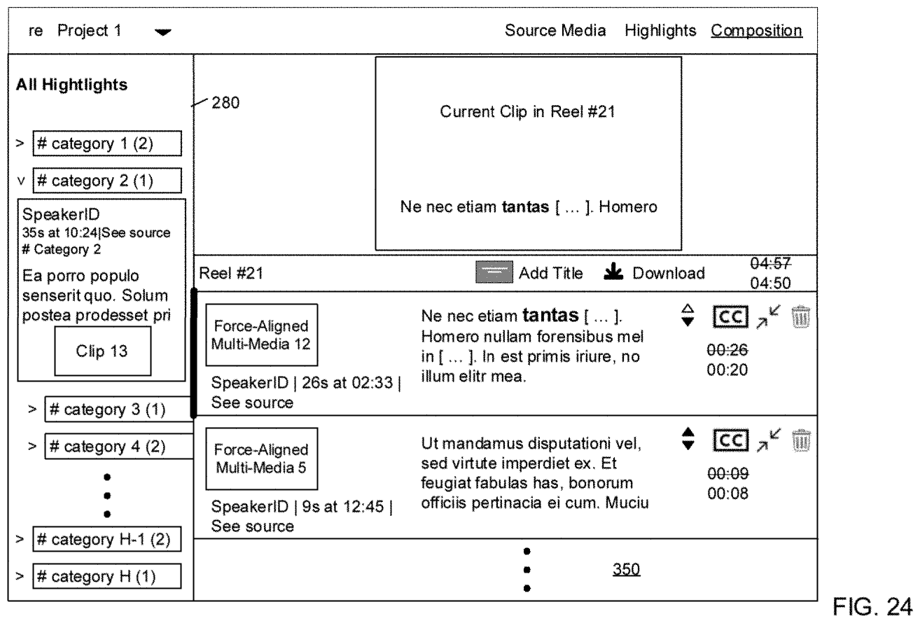

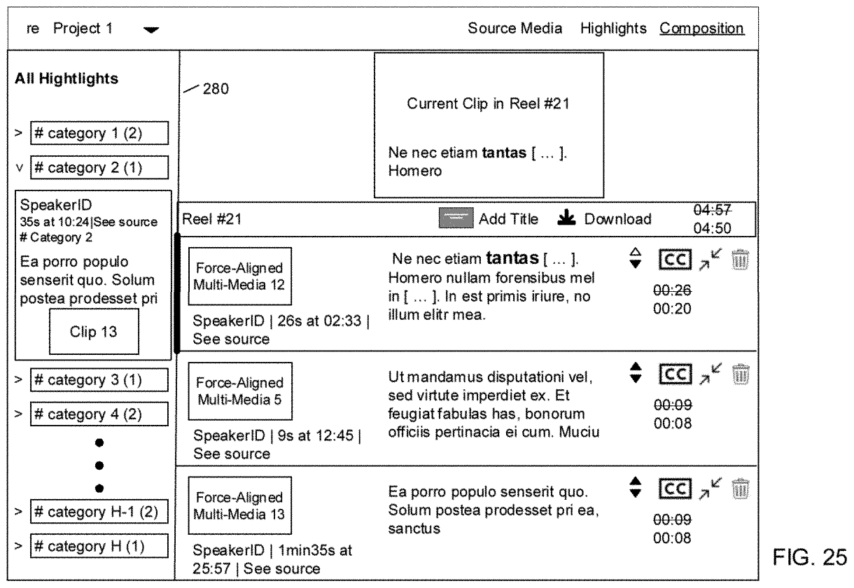

Referring to FIG. 24, the user may add another highlight to the current reel, by toggling the rightward facing arrow for category 2 to reveal the single individual highlight grouped under category 2. The user can select the desired individual highlight 306 and drag it from the left sidebar and drop it into the editing interface 350 below the other highlights to add the selected individual highlight to the end of the highlight sequence, as shown in FIG. 25.

In addition to the above-described web application, there is an example mobile-first version of the web application that supports many of the same features (e.g., search, strike-through editing, and burn-in downloads) from a mobile touchscreen enabled, processor operated mobile device. The text-based editing capabilities of the mobile device allow for extremely rapid and precise edits, even with the mobile form-factor.

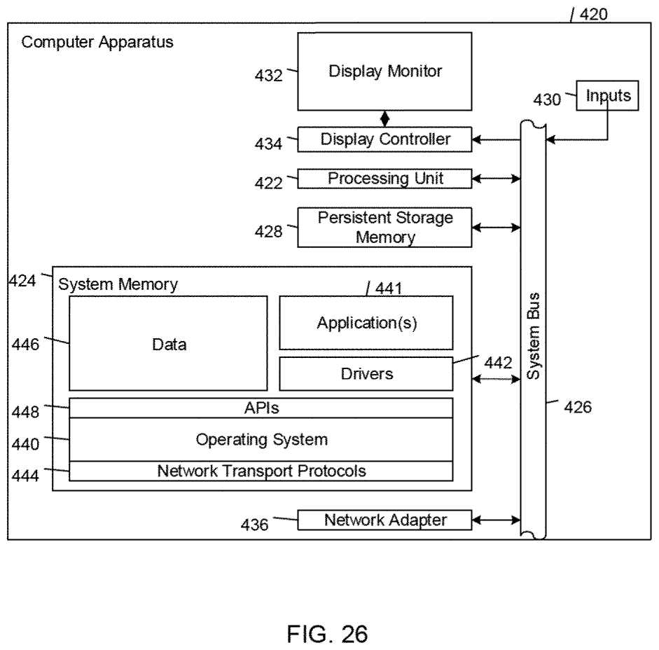

FIG. 26 shows an example embodiment of computer apparatus that is configured to implement one or more of the systems described in this specification. The computer apparatus 420 includes a processing unit 422, a system memory 424, and a system bus 426 that couples the processing unit 422 to the various components of the computer apparatus 420. The processing unit 422 may include one or more data processors, each of which may be in the form of any one of various commercially available computer processors. The system memory 424 includes one or more computer-readable media that typically are associated with a software application addressing space that defines the addresses that are available to software applications. The system memory 424 may include a read only memory (ROM) that stores a basic input/output system (BIOS) that contains start-up routines for the computer apparatus 420, and a random access memory (RAM). The system bus 426 may be a memory bus, a peripheral bus or a local bus, and may be compatible with any of a variety of bus protocols, including PCI, VESA, Microchannel, ISA, and EISA. The computer apparatus 420 also includes a persistent storage memory 428 (e.g., a hard drive, a floppy drive, a CD ROM drive, magnetic tape drives, flash memory devices, and digital video disks) that is connected to the system bus 426 and contains one or more computer-readable media disks that provide non-volatile or persistent storage for data, data structures and computer-executable instructions.

A user may interact (e.g., input commands or data) with the computer apparatus 420 using one or more input devices 430 (e.g. one or more keyboards, computer mice, microphones, cameras, joysticks, physical motion sensors, and touch pads). Information may be presented through a graphical user interface (GUI) that is presented to the user on a display monitor 432, which is controlled by a display controller 434. The computer apparatus 320 also may include other input/output hardware (e.g., peripheral output devices, such as speakers and a printer). The computer apparatus 420 connects to other network nodes through a network adapter 336 (also referred to as a “network interface card” or NIC).

A number of program modules may be stored in the system memory 424, including application programming interfaces 438 (APIs), an operating system (OS) 440 (e.g., the Windows® operating system available from Microsoft Corporation of Redmond, Wash. U.S.A.), software applications 441 including one or more software applications programming the computer apparatus 420 to perform one or more of the steps, tasks, operations, or processes of the hierarchical classification systems described herein, drivers 442 (e.g., a GUI driver), network transport protocols 444, and data 446 (e.g., input data, output data, program data, a registry, and configuration settings).

Examples of the subject matter described herein, including the disclosed systems, methods, processes, functional operations, and logic flows, can be implemented in data processing apparatus (e.g., computer hardware and digital electronic circuitry) operable to perform functions by operating on input and generating output. Examples of the subject matter described herein also can be tangibly embodied in software or firmware, as one or more sets of computer instructions encoded on one or more tangible non-transitory carrier media (e.g., a machine readable storage device, substrate, or sequential access memory device) for execution by data processing apparatus.

The details of specific implementations described herein may be specific to particular embodiments of particular inventions and should not be construed as limitations on the scope of any claimed invention. For example, features that are described in connection with separate embodiments may also be incorporated into a single embodiment, and features that are described in connection with a single embodiment may also be implemented in multiple separate embodiments. In addition, the disclosure of steps, tasks, operations, or processes being performed in a particular order does not necessarily require that those steps, tasks, operations, or processes be performed in the particular order; instead, in some cases, one or more of the disclosed steps, tasks, operations, and processes may be performed in a different order or in accordance with a multi-tasking schedule or in parallel.

Outline of Related Subject Matter

The following is an outline of related subject matter.

1. A computer-implemented method of parsing and synthesizing spoken media sources to create multimedia for a project, comprising:

displaying one of the spoken media sources in a media player in a first pane of a first interface and a respective synchronized transcript of the spoken media source in a second pane of the first interface;

creating a highlight for the spoken media source, wherein the creating comprises associating the highlight with a text string excerpt from the respective synchronized transcript and a tag labeled with a respective category descriptor;

repeating the displaying and the creating for one or more of the spoken media sources, wherein each tag is associated with a unique category descriptor and one or more highlights;

displaying the highlights in a first pane of a second interface, wherein displaying the highlights comprises presenting at least portions of the respective text string excerpts of the highlights grouped according to their associated tags, wherein each group is labeled with the category descriptor for the associated tag;

associating selected ones of the highlights with a second pane of the second interface in a sequence, and automatically concatenating clips of the spoken media sources corresponding to and synchronized with the selected highlights according to the sequence; and

displaying the sequence of concatenated clips of the spoken media sources in a media player in a third pane of the second interface synchronized with displaying the text string excerpts in the second pane of the second interface.

2. The method of claim 1, wherein each highlight is displayed in a respective highlight panel in the first pane of the second interface.

3. The method of claim 2, wherein the highlight panels displayed in the first pane of the second interface are listed alphabetically by category descriptor.

4. The method of claim 2, wherein each highlight panel displayed in the first pane of the second interface comprises a respective tag category descriptor associated with a respective link to a third interface for displaying all highlights associated with the project.

5. The method of claim 1, further comprising displaying in a third pane of the first interface a set of one or more highlight panels each of which comprises: a respective text string excerpt derived from a transcript currently displayed in the second pane of the first interface.

6. The method of claim 5, wherein each highlight panel in the third pane of the first interface is linked to a respective text string excerpt in the transcript currently displayed in the second pane of the first interface.

7. The method of claim 6, wherein selection of the highlight presents a view of the respective text string excerpt in the transcript in the second pane.

8. The method of claim 6, wherein each highlight panel in the third pane of the first interface is linked to a third interface for displaying all highlights associated with the project.

9. The method of claim 1, wherein the associating comprises dragging a selected highlight from the first pane of the second interface and dropping the selected highlight into the second pane of the second interface.

10. The method of claim 9, wherein each highlight in the second pane in the second interface is displayed in a highlight panel comprising a respective link to the respective spoken media source and the respective text string excerpt.

11. The method of claim 10, wherein selection of the respective link displays the respective media source in the media player in the first pane of the first interface time-aligned with the respective text string excerpt in the respective synchronized transcript.

12. The method of claim 1, further comprising: generating subtitles comprising words from the text string excerpts synchronized with speech in the sequence of concatenated clips; and displaying the subtitles over the sequence of concatenated clips in the second pane of the second interface.

13. The method of claim 12, further comprising automatically replacing text deleted from one or more of the highlighted text strings with a deleted text marker, and displaying the deleted text marker in the subtitles displayed in the second pane of the second interface.

14. The method of claim 12, further comprising, responsive to the deletion of text from the one or more of the highlighted text strings, automatically deleting a segment of audio and video content in the sequence of concatenated clips that is force-aligned with the deleted text.

15. The method of claim 1, further comprising applying typographical emphasis to one or more words in the text string excerpts, and automatically applying a media effect synchronized with playback of the sequence of concatenated clips in the second pane of the second interface.

16. The method of claim 15, wherein the typographical emphasis comprises applying bold emphasis to the one or more words from the text string excerpts, automatically applying a volume increase effect synchronized with playback of the sequence of concatenated clips in the second pane of the second interface.

17. The method of claim 1, further comprising receiving a search term in a search box of the first interface, searching exact word matches to the received search term in a corpus comprising words from the transcripts of all spoken media sources associated with the project, and using a word embedding model to expand the search results to words from the transcripts that match search terms that are similar to the received search terms.

18. The method of claim 1, further comprising in a search pane of the first interface:

receiving a search term entered in a search box and, in response, matching the search term to exact word or phrase matches in a corpus comprising all words in a dictionary that intersect with words associated with the project;

presenting, in a results pane, one or more extracts from each of the transcripts that comprises exact word or phrase matches to the search term.

19. The method of claim 18, wherein each of the extracts is presented in the first interface in a respective panel that comprises a respective link to a start time in the respective media source.

20. The method of claim 18, further comprising identifying search terms that are similar to the received search terms using a word embedding model that maps search terms to word vectors in a word vector space and returns one or more similar search terms in the corpus that are within a specified distance from the received search term in the word vector space.

21. The method of claim 20, wherein the presenting comprises presenting the one or more similar search terms for selection, and in response to selection of one or more of the similar search terms presenting one or more respective extracts from one or more of the transcripts comprising one or more of the selected similar search terms.

22. The method of claim 18, further comprising:

switching from the first interface to a fourth interface;

responsive to the switching, automatically presenting in the fourth interface the search box and the results pane in the same state as they were in the first interface before switching.

23. The method of claim 22, wherein the fourth interface comprises an interface element for uploading spoken media sources for the project, and a set of panels each of which is associated with a respective uploaded spoken media source and a link to the first interface.

24. Apparatus comprising a memory storing processor-readable instructions, and a processor coupled to the memory, operable to execute the instructions, and based at least in part on the execution of the instructions operable to perform operations comprising:

displaying one of the spoken media sources in a media player in a first pane of a first interface and a respective synchronized transcript of the spoken media source in a second pane of the first interface;

creating a highlight for the spoken media source, wherein the creating comprises associating the highlight with a text string excerpt from the respective synchronized transcript and a tag labeled with a respective category descriptor;

repeating the displaying and the creating for one or more of the spoken media sources, wherein each tag is associated with a unique category descriptor and one or more highlights;

displaying the highlights in a first pane of a second interface, wherein displaying the highlights comprises presenting at least portions of the respective text string excerpts of the highlights grouped according to their associated tags, wherein each group is labeled with the category descriptor for the associated tag;

associating selected ones of the highlights with a second pane of the second interface in a sequence, and automatically concatenating clips of the spoken media sources corresponding to and synchronized with the selected highlights according to the sequence; and

displaying the sequence of concatenated clips of the spoken media sources in a media player in a third pane of the second interface synchronized with displaying the text string excerpts in the second pane of the second interface.

25. A computer-readable data storage apparatus comprising a memory component storing executable instructions that are operable to be executed by a computer, wherein the memory component comprises:

executable instructions to display one of the spoken media sources in a media player in a first pane of a first interface and a respective synchronized transcript of the spoken media source in a second pane of the first interface;

executable instructions to create a highlight for the spoken media source, wherein the creating comprises associating the highlight with a text string excerpt from the respective synchronized transcript and a tag labeled with a respective category descriptor;

executable instructions to repeat the displaying and the creating for one or more of the spoken media sources, wherein each tag is associated with a unique category descriptor and one or more highlights;

executable instructions to display the highlights in a first pane of a second interface, wherein displaying the highlights comprises presenting at least portions of the respective text string excerpts of the highlights grouped according to their associated tags, wherein each group is labeled with the category descriptor for the associated tag;

executable instructions to associate selected ones of the highlights with a second pane of the second interface in a sequence, and automatically concatenating clips of the spoken media sources corresponding to and synchronized with the selected highlights according to the sequence; and

executable instructions to display the sequence of concatenated clips of the spoken media sources in a media player in a third pane of the second interface synchronized with displaying the text string excerpts in the second pane of the second interface.

1. A computer-implemented method of creating time-aligned multimedia based on a transcript of spoken words, comprising:
receiving source media at a service server;
deriving a master audio track from the source media, wherein the master audio track comprises a sequence of audio parts and audio timing data;
procuring transcripts for the audio parts by the service server;
automatically force-aligning the transcripts with the master audio track to produce a master transcript, wherein force-aligning the transcripts comprises aligning text in each transcript with respective time intervals of corresponding spoken words in the master audio track;
obtaining from the source media a second media track associated with a second audio track; and
force-aligning the second media track of timed source media with the master transcript, wherein time-aligning the second track comprises aligning time intervals of spoken words in the second audio track with corresponding text in the master transcript.

2. The method of claim 1, wherein the second audio track overlaps a particular timeframe of the master audio track.

3. The method of claim 2, further comprising, by the service server, automatically replacing a time interval of audio content in the master audio track with corresponding audio in the second audio track based on an indication that the second audio track is higher quality than the master audio track.

4. The method of claim 1, wherein the procuring comprises, by the service server, dividing the audio parts into audio segments, requesting transcripts of the audio segments, and receiving transcripts of the audio segments.

5. The method of claim 4, wherein the dividing comprises dividing, by the service server, the audio parts into a sequence of audio segments, and each successive audio segment has a respective initial padding portion with audio content that overlaps a terminal portion of an adjacent preceding audio segment.

6. The method of claim 5, wherein time-aligning the transcripts comprises resolving boundaries between successive transcripts.

7. The method of claim 6, wherein the resolving comprises starting each successive transcript at a time code immediately following the last word in the adjacent preceding transcript.

8. The method of claim 6, wherein the transcripts are time-aligned with respect to an ordered arrangement of the source media.

9. The method of claim 6, wherein the time-aligning of the transcripts comprises aligning words in each transcript with the time intervals of matching speech in the sequence of audio parts.

10. The method of claim 1, wherein the second media track comprises a sequence of video frames that are force-aligned with the master transcript.

11. The method of claim 10, wherein the force-aligned sequence of video frames spans a first portion of the master transcript.

12. The method of claim 11, wherein a third media transcript comprises a sequence of video frames that are force-aligned with the master transcript.

13. The method of claim 12, wherein the second and third time-aligned media tracks do not overlap.

14. The method of claim 13, wherein the second and third timed media tracks are sourced from a single recording device.

15. The method of claim 13, wherein the second and third timed media tracks are sourced from different recordings devices.

16. The method of claim 1, wherein the master transcript is associated with time codes, and the second set of timed source media is associated with time offsets from the time codes associated with the master transcript.

17. The method of claim 1, further comprising:
based on the force-aligning of the second set of timed source media, ascertaining a level of drift between words in the second set of timed source media relative to corresponding words in the master transcript; and
based on a determination that the level of drift exceeds a drift threshold, correcting drift in the second set of timed source media.

18. The method of claim 17, wherein the correcting comprises computing a linear best fit of time offsets of the second set of timed source media from the master transcript over a drift period, and projecting the computed time offsets from the master transcript to correct the second set of timed source media.

19. Apparatus comprising a memory storing processor-readable instructions, and a processor coupled to the memory, operable to execute the instructions, and based at least in part on the execution of the instructions operable to perform operations comprising:
receiving source media at a service server;
deriving a master audio track from the source media, wherein the master audio track comprises a sequence of audio parts and audio timing data;
procuring transcripts for the audio parts by the service server;
automatically force-aligning the transcripts with the master audio track to produce a master transcript, wherein force-aligning the transcripts comprises aligning text in each transcript with respective time intervals of corresponding spoken words in the master audio track;
obtaining from the source media a second media track associated with a second audio track; and
force-aligning the second media track of timed source media with the master transcript, wherein time-aligning the second track comprises aligning time intervals of spoken words in the second audio track with corresponding text in the master transcript.

20. A computer-readable data storage apparatus comprising a memory component storing executable instructions that are operable to be executed by a computer, wherein the memory component comprises:
executable instructions to receive source media at a service server;
executable instructions to derive a master audio track from the source media, wherein the master audio track comprises a sequence of audio parts and audio timing data;
executable instructions to procure transcripts for the audio parts by the service server;
executable instructions to automatically force-align the transcripts with the master audio track to produce a master transcript, wherein force-aligning the transcripts comprises aligning text in each transcript with respective time intervals of corresponding spoken words in the master audio track;
executable instructions to obtain from the source media a second media track associated with a second audio track; and
executable instructions to force-align the second media track of timed source media with the master transcript, wherein force-aligning the second track comprises aligning time intervals of spoken words in the second audio track with corresponding text in the master transcript.
